(19) United States
(12) Patent Application Publication
(10) Pub. No.: US 2008/0055392 A1
(43) Pub. Date: Mar. 6, 2008

(54) BI-directionally scanning electrophotographic device corrected per ambient pressure and temperature

(75) Inventors: Craig P. Bush, Lexington, KY (US); Martin C. Klement, Lexington, KY (US); Daniel R. Klemer, Lexington, KY (US); David J. Mickan, Lexington, KY (US); Wilson M. Routt, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/512,475

(22) Filed: Aug. 30, 2006

(51) Int. Cl. B41J 2/435

(52) U.S. Cl. 347/247

(57) ABSTRACT

Methods and apparatus include improving print quality of a bi-directionally scanning electrophotographic (EP) device, such as a laser printer or copy machine, according to either or both of ambient pressure and temperature in which operated. A moving galvanometer or oscillator reflects a laser beam to create scan lines of a latent image in opposite directions. A damping of the motion of the galvanometer or oscillator occurs per the pressure and temperature and is, thus, characterized. During use, the actual ambient pressure and temperature are obtained and correlated to the characterization. Corrections to improve print quality then occur according to the characterization. Certain corrections include producing the latent image with a signal altered from an image data input signal. Delaying contemplates fractions of pixels and whether a left or right half or a forward or reverse scan line of the image is under consideration.

### FIELD OF THE INVENTION

Generally, the present invention relates to electrophotographic (EP) devices, such as laser printers or copy machines. Particularly, it relates to improving print quality in electrophotographic devices utilizing bidirectional scanning. In one aspect, EP devices are characterized according to pressure and temperature. In another, ambient operating conditions are obtained and corrections implemented. In still other aspects, pixel information for scanning is altered according to expected misalignments per the ambient operating conditions.

### BACKGROUND OF THE INVENTION

Traditional electrophotographic (EP) devices have a spinning polygon mirror that directs a laser beam to a photoconductor, such as a drum, to create one or more scan lines of a latent to-be-printed image. Recently, however, it has been suggested that torsion oscillator or resonant galvanometer structures can replace the traditional spinning polygon mirror and create scan lines in both the forward and reverse directions (e.g., bi-directionally) and increase efficiency of the EP device. Because of their MEMS scale size and fabrication techniques, the structures are also fairly suggested to reduce the relative cost of manufacturing. Unfortunately, scanning in two directions adds a measure of complexity to image referencing since reference points need occur for each of the forward and reverse scans at opposite ends of the printed page and the slightest of deviations amplifies print image imperfections. Also, any asymmetry in the motion of the oscillator or galvanometer results in errors in print linearity and line-to-line registration across the printing area.

In an ideal bi-directionally scanning EP device, the oscillator or galvanometer is well controlled by a drive configuration to move it sinusoidally without impedance. Because of modern design constraints, however, sinusoidal drives are somewhat impractical or economically infeasible. In turn, a more practical drive configuration consists of a sequence of pulses, each of which cause a corresponding force to be imparted to the galvanometer or oscillator to make it move. Problematically, there is a notable drawback in the discontinuous nature by which forces are applied to the galvanometer or oscillator which causes an asymmetric distortion of laser scanning motion.

Since the mechanical properties of the constituent materials that compose the galvanometer or oscillator are influenced by temperature, and the damping of the motion is dependent on air density (in turn, a result of both temperature and pressure, where pressure varies with altitude, for instance), it is clear that ambient operating conditions affect the shape and magnitude of the linearity and misalignment of scan lines. In this regard, print quality changes occur as a result of changes in operating altitude, temperature or from large barometric changes, for example.

Accordingly, there exists a need in the art for characterizing the manner in which bi-directionally scanning EP devices should operate according to various pressures and temperatures. Particularly, there are needs by which knowing the actual operating conditions of the EP device will relate to making corrections to improve print quality. Ultimately, the need extends to accurately aligning and registering the pixel information of the forward and reverse bi-directional scan lines. Naturally, any improvements should further contemplate good engineering practices, such as relative inexpensiveness, stability, low complexity, ease of implementation, etc.

### SUMMARY OF THE INVENTION

The above-mentioned and other problems become solved by applying the principles and teachings associated with the hereinafter described bi-directionally scanning electrophotographic (EP) devices, such as laser printers or copier machines, corrected per ambient operating conditions, such as pressure and temperature. In a most basic sense, an EP device is pre-characterized such that pressure and temperature are correlated to expected positional misalignment of scan lines. Based upon attainment of actual ambient operation conditions, the EP device under consideration is corrected to prevent or otherwise overcome the expected positional misalignment.

In this regard, an EP device includes a scanning mechanism in the form of a moving galvanometer or oscillator that reflects a laser beam to create scan lines of a latent image in opposite directions. A damping of the motion of the galvanometer or oscillator occurs per the ambient pressure and temperature operating conditions and such is compared to a pre-characterization of same. Corrections to improve print quality then occur according to the characterization. Certain corrections include producing the latent image with a signal altered from an image data input signal. Especially, fractions of pixels of image data input are delayed to the presentation of the laser beam and such occur per either a left or right half or a forward or reverse scan line of the image under consideration.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative bi-directionally scanning EP device;

FIG. 2 is a diagrammatic view in accordance with the present invention of desirable scan lines and reference positions in a bi-directionally scanning EP device;

FIG. 3 is a diagrammatic view in accordance with the present invention of a more detailed version of a scanning mechanism of the EP device of FIG. 1;

FIG. 4 is a graph in accordance with the present invention of desirable sinusoidal and pulsed drive signals for the scanning mechanism;

FIG. 5 is a diagrammatic view in accordance with the present invention of a representative distortion of a laser spot potentially occurring in the EP device of FIG. 1;

FIGS. 6A and 6B are graphs in accordance with the present invention of empirical and theoretic misalignment data representative of potential misalignments in a bi-directionally scanning EP device;

FIG. 7 is a graph in accordance with the present invention of empirical misalignment as a function of various pressures;

FIG. 8 is a surface plot in accordance with the present invention of a representative model pre-characterizing an EP device according to pressure and temperature;

FIG. 9 is a diagrammatic view in accordance with the present invention of a representative correction to a video signal of an EP device; and

FIG. 10 is a flow chart in accordance with the present invention of a representative algorithm for implementing the correction of FIG. 9.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, software, and/or other changes may be made without departing from the scope of the present invention. In accordance with the present invention, a bi-directionally scanning electrophotographic (EP) device corrected per ambient operating conditions, such as pressure and temperature, is hereafter described.

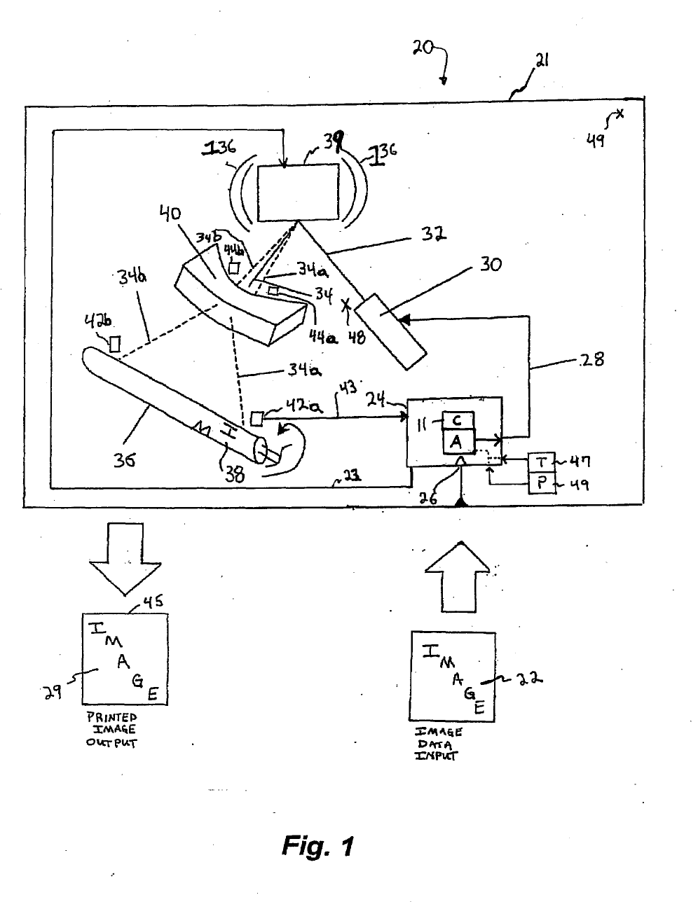

With reference to FIG. 1, an EP device 20 of the invention representatively includes mono or color laser printers or copier machines. During use, image data 22 is supplied to the EP device from somewhere external, such as from an attendant computer, camera, scanner, PDA, laptop, etc. A controller 24 receives the image data at an input 26 and configures an appropriate output, video signal 28 to produce a latent image of the image data. Ultimately, a hard-copy printed image 29 of the image data is obtained from the latent image. If print alignment and operating conditions of the EP device are well calibrated, the printed image 29 corresponds nearly exactly with the image data input 22. If not, the printed image has poor quality, especially in the form of a variety of misalignments.

With more specificity, the output, video signal 28 energizes a laser 30 to produce a beam 32 directed at a scanning mechanism 39, such as a torsion oscillator or resonant galvanometer. As the oscillator or galvanometer moves (indicated by oscillation wave lines 136) the beam 32 is reflectively cast to create beam lines 34a, 34b on either side of a central position 34. As a result, multiple scan lines in alternate directions are formed on a photoconductor 36, such as a drum, and together represent a latent image 38 of the image data supplied to the controller. Optically, certain lenses 40, mirrors or other structures exist intermediate to the photoconductor to transform the rotational scan of the laser beam reflected from the oscillator or galvanometer 39 into a substantially linear scan of the beam at the photoconductor 36, with substantially uniform linear scan velocity and with substantially uniform laser beam spot size along the imaging area of the drum. To provide common reference for the beam lines, various sensors are employed. Preferably, a forward sensor 42a and a reverse sensor 42b, called horizontal synchronization (hsync) sensors, are positioned near opposite ends of the photoconductor to provide a common reference for all forward scanning beam lines and all backward scanning beam lines, respectively. In addition to, or in lieu of the sensors 42a, 42b, forward and reverse hsync sensors may be positioned at 44a and 44b, upstream of the representative optics 40. Alternatively still, a single hsync sensor might be used with one or more mirrors emplaced variously to act as a second hsync sensor. Regardless, the outputs of these sensors (representatively given as line 43 from hsync sensor 42a) are supplied to the controller 24 for referencing correct locations of the scan line(s) of the latent images. Downstream of the latent image, and not shown, the printed image is formed by applying toner to the latent image and transferring it to a media, such as a sheet of paper. Thereafter, the media 45 with the printed image 29 exits the EP device, where users handle it for a variety of reasons.

Unfortunately, the printed image 29 is not always an accurate representation of the image data input 22 and various operations are employed to tightly calibrate the EP device. In this regard, a temperature and pressure sensor 47 and 49 are provided to supply input to the controller to correct the EP device per ambient operating conditions, such as pressure and temperature. An algorithm A then uses the obtained pressure and temperature to implement a correction in the output, video signal 28 from the supplied image data input signal at 26. In placement, the sensors can typify any location internal or external to the EP device although both are shown generally nearby the controller, within a housing 21. However, a more likely position for the temperature sensor 47 is that of being nearby the laser beam 30 at position 48, for instance, to better ascertain the temperature of the structures that actually form the scan lines of the latent image. As a corollary, a more likely position of the pressure sensor is that of being relatively far away from any moving structures able to influence air flow, such as at position 49, so that pressure readings are not unduly influenced by fluctuating air. In form, the temperature sensor may representatively embody items such as a temperature sense resistor, a thermocouple, a thermistor, or any other detector influenced by thermal variations. Pressure sensors, on the other hand, may representatively embody items such as a diaphragm, a transducer, a capacitor, or any other detector influenced by pressure variations. Pressure may be also inferred from other components of the EP device, as will be described below, without need of taking direct pressure readings.

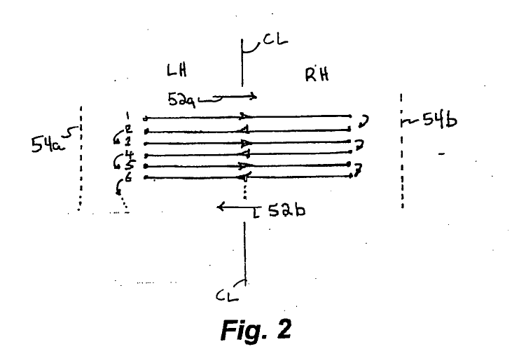

Before then, however, FIG. 2 conceptually shows the desired scan lines and reference positions in a bi-directionally scanning EP device and fairly suggests the nomenclature for use with later figures. Namely, a plurality of scan lines forming a latent image on a photoconductor, for example, are sequentially numbered 1-6, with odd numbered scan lines (1, 3, and 5) occurring in a forward scan direction 52a opposite the even numbered scan lines (2, 4, and 6) occurring in a reverse scan direction 52b. Also, the forward and reverse scan lines alternate with one another and such is the nature of scanning with the torsion oscillator or resonant galvanometer and its attendant formation of forward-scanning beam lines 34a and reverse-scanning beam lines 34b. Also, the reference position 54a supplies a common reference point for each of the forward scanning lines and is borne about by the signal from the forward hsync sensor. Conversely, the reference position 54b supplies a common reference point for each of the backward scanning lines and is borne about by the signal from the reverse hsync sensor.

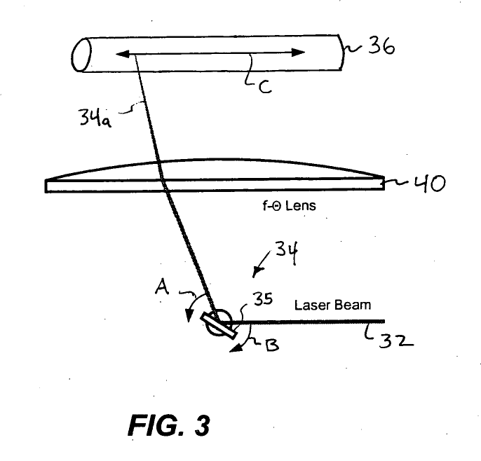

With reference to FIG. 3, a slightly more detailed version of the scanning mechanism 39, such as a galvanometer or oscillator, of the EP device is shown. In this regard, the scanning mechanism includes a reflective surface 35, such as a mirror, that is caused to rotate about a central pivot point in either a first direction given by arrow A or in an opposite direction given by arrow B. The laser beam 32 upon hitting the reflective surface is then caused to impinge upon the photoconductor 36 to make scan lines of a latent image in opposite directions given by bi-directional arrow C. Also, drive means (not shown) exert a torque on the scanning mechanism to push it, so to speak, to rotate (in either the direction of arrow A or B). In this regard, the torque occurs for a relatively short period of time, but adds a sufficient amount of energy to the system of the scanning mechanism so that correct scan amplitude is maintained for at least both a right half of a forward scan and a right half of a scan in the reverse. Upon the scanning mechanism reaching a corresponding mid-point or centerline of its scan line, the scanning mechanism is similarly pushed (now in the opposite direction of either arrow A or B) to complete the left half of the reverse scan line, followed by the left half of the forward scan line. Over time, the process repeats and multiple scan lines are produced. By analogy, the scanning mechanism is akin to a pendulum that gets pushed in both a forward and reverse direction. By operation of gravity and other forces, the pendulum reverses direction on its own as it transitions from the forward to the reverse directions at the apex. Diagrammatically, this is seen in FIG. 2 relative to a scanning mechanism according to the right half RH and left half LH appearing on opposite sides of a centerline CL. It is also the case that the highest drive efficiency is achieved when the frequency of the push of the scanning mechanism (or pendulum, by analogy) coincides with the resonant frequency of the scanning mechanism.

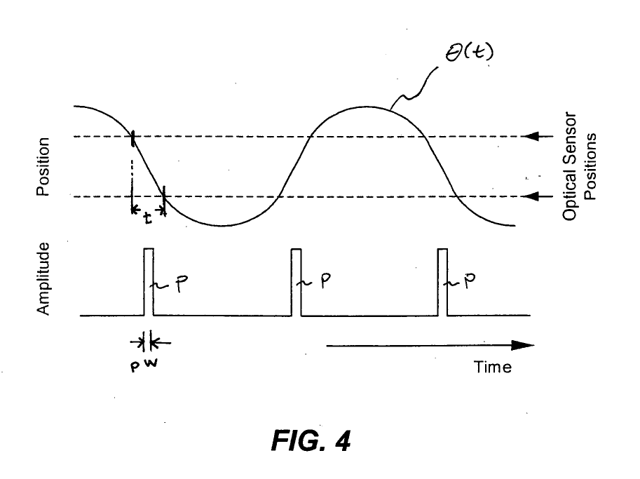

With reference to FIG. 4, assuming that the optics are designed to appropriately transform the nonlinear angular motion of the laser beam reflected from the mechanism into linear motion of the laser spot on a photoconductor, the ideal motion of the mechanism driven by an appropriate electronic driver is described by the sinusoidal equation:

θ(t)=A·sin (ω·t) Equation 1;

where θ(t) is the instantaneous angular position of the mechanism, with θ=0 occurring at the centerline (CL, FIG. 2) of the scan, A being the maximum excursion of the beam, ω being the radian frequency of the motion, and t being the time. Akin to the pendulum analogy, the amplitude and frequency of the motion are controlled by the driver, but the most efficient operation occurs if the scanning mechanism is driven or pushed at or near its natural resonance point. While the actual motion of the laser spot is affected by several factors, including for example, (1) the drive method and configuration of the scanning mechanism, (2) nonlinear damping of the scanning mechanism, (3) misalignment of the scanning mechanism, and (4) nonlinearity of various optics in the EP device (such as element 40), near-ideal motion can be obtained if the drive mechanism could, indeed, follow the θ(t) curve. As before, however, design constraints generally make such impractical or economically unfavorable. Thus, the more practical drive approach is shown via a sequence of pulses P, each of which causes a corresponding force to be imparted to the scanning mechanism at a time to make it resonate at its resonant frequency. Such also occurs by imparting an electromagnetic, electrostatic or other force and coupling it to the scanning mechanism via an appropriately positioned electromagnetic, electrostatic, or other coupling receiver (not shown). While the amplitude of the pulses is fixed, the duration pw of each pulse can be dynamically varied to maintain consistent scan times as measured by optical sensors, (e.g., hsync sensors) according to the shown time t, which intercept the scanning laser beam on either end of the scan lines. In general, the greater the air resistance in the operating environment, the wider or longer the pulse width that is required. Conversely, the lesser the air resistance in the operating environment, the shorter the pulse width that is required. Regardless, both the lengthening and shortening of the pulse width occurs via a feedback drive scheme. This drive scheme is also particularly well suited to a controller 24 of FIG. 2 contemplative of a digital control system in which a digital controller (e.g. microcontroller, microprocessor, DSP, ASIC, or FPGA) is designed to provide pulses of precise duration and timing to the scanning mechanism, such as along control line 23, and to accurately measure the timing of feedback signals, e.g., line 43, from the sensors.

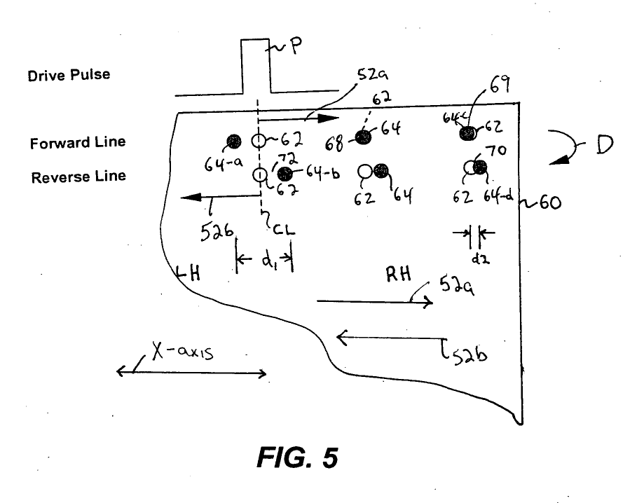

With reference to FIG. 5, a drive pulse P for pushing a scanning mechanism is shown relative to how desired and undesired pixels (pels) occur on adjacent forward and reverse scan lines in a portion of the printing area 60. Namely, white circles 62 indicate ideal or desired pel locations, while solid or darkened circles 64 indicate actually-printed pel locations. During use, when the drive pulse P is applied, there is a small deviation from the ideal scan. Damping caused primarily by air resistance slows the scanning mechanism as it moves through one half cycle (e.g., a right half RH of the printing area 60 relative to the centerline CL), which in turn causes successive pels to lag (alternatively, lead—not shown) in the direction of travel, resulting in print nonlinearity. The amount of deviation between the ideal and actual pel locations, e.g., circles 62 compared to circles 64, respectively, increases over time as the effect of the applied force is damped. For instance, as the scanning mechanism creates a scan line in the forward direction toward the right half RH of the printing area 60 relative to the centerline CL, the darkened circle 64 and the underlying white circle 62 align and register fairly well at a position 68 near the centerline. As travel of the scan line progresses, however, the alignment and registration of the white and darkened circles varies, such as at position 69, such that the ideal and the actual pels do not align perfectly. Continuing, the scan line reverses course from a forward direction 52a to a reverse direction 52b, according to the representative arrow D, and alignment and registration of the ideal and actual pels separates even further, such as at position 70. Ultimately, the mismatch between the ideal and actual is greatest near the centerline CL, such as near position 72, before scanning in the reverse direction occurs in the direction 52b for the left half LH of the printing area 60. As is then seen, the resulting linearity error varies across the scan lines, with the maximum error occurring at or near the centerline CL position at which the drive pulses occur. Moreover, non-linearity produced in reverse scan lines is opposite in direction to that produced in forward scan lines, and therefore, a misalignment between pels on adjacent scan lines will occur with a maximum alignment error of double the linearity error.

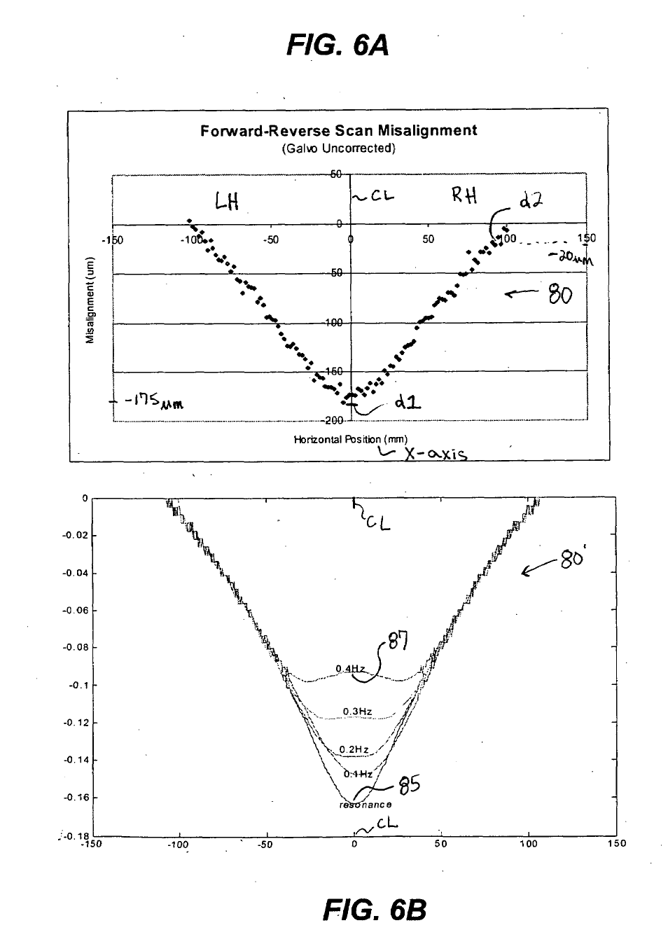

Plotting this out, FIGS. 6A and 6B show empirical and theoretical results, respectively, resembling a “V” shaped curve 80 and 80′. In FIG. 6A, numerous sample points were obtained in creating curve 80 for an EP device and skilled artisans will observe that the closer the scan line is to the centerline, the worse the misalignment between the ideal and the actual pel locations. Because only actual pels can be measured relative to other pels, and not ideal pels relative to actual pels, the graph more precisely represents distances of misalignment relative to adjacent pels, and adjacent pels in adjacent scan lines (forward versus reverse scan line, and vice versa). Correlating back to FIG. 5, a distance d1 exists of about 175 microns between adjacent darkened circles 64-a and 64-b near the centerline CL. Further away from the centerline CL, however, the distance between pels is much closer together. In other words, the misalignment is less at distance d2 between adjacent darkened circles 64-c and 64-d compared to distance d1. Skilled artisans will also note that the horizontal position on the graph (x-axis) extends to about +/−100 mm in length. By converting to inches, a media of about 8.5 inches wide by 11 inches long has about +/−108 mm per each left and right half LH, RH of the 8.5 inches relative to centerline and a few millimetres per the 8.5 inch-wide media is unused. That is, about 8 mm per each of the left and right halves of the media are not printed on and, thus, has no misalignment and the empirical data only covers the +/−100 mm.

In FIG. 6B, it is shown that the theoretical curve 80′ of misalignment corroborates the empirical curve 80 of misalignment, with the greatest amount of misalignment occurring near the centerline. It also indicates that a scanning mechanism exhibits somewhat distorted misalignment near the centerline, at position 85 for instance, from a pulse train whose frequency does not match the resonant frequency of the scanning mechanism, thereby creating a phase shift between the drive pulse train and the scanning motion of the scanning mechanism.

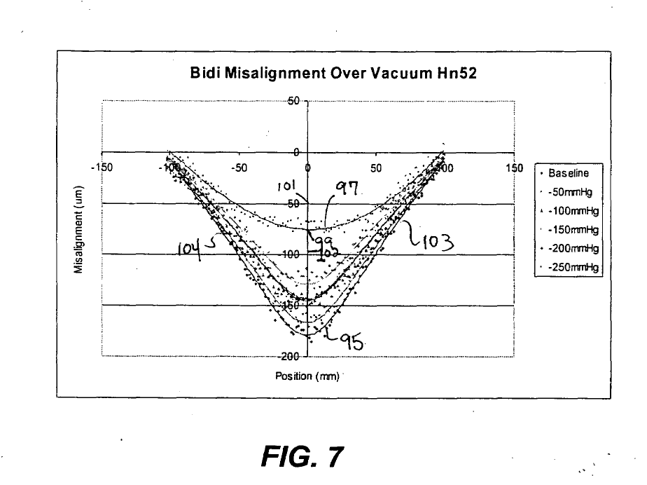

With reference to FIG. 7, a plurality of superimposed curves are given showing empirical or measured misalignment profiles changed as a function of relative air pressure reduction, which certainly occurs as a result of changes in altitude of the operating environment. In this regard, a baseline plot 95 is given for a standard operating pressure, such as at 29.92 inches of mercury (Hg). Thereafter, the plots are given relative to the baseline in millimeters of mercury (Hg). As is apparent, the misalignment improves with lower pressure, or at higher altitude, such is given by plot 97. Correspondingly, the steepness of the V-shaped profile will flatten-out or “steepen-up” as will the legs 103, 104 of the profile have a variable amount of slope, as will be better defined below. Relative to temperature changes, the V-shaped plots would either rise or lower from, for example, having an apex 99 to either having an apex at position 101 or having an apex at 102, respectively, as temperature increased or decreased, respectively.

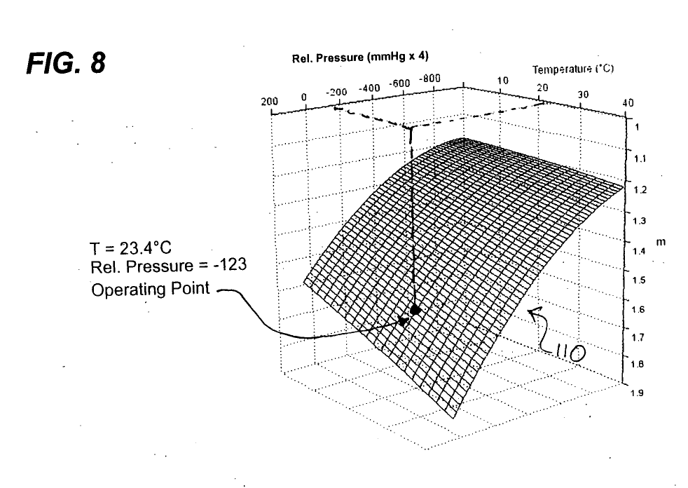

Accordingly, the inventors have empirically and theoretically shown that misalignment gets better or worse according to various pressures and temperatures of an operating environment in which a bi-directionally scanning EP device is operated. With reference to FIG. 8, modeling or pre-characterizing this results in a set of surface plots, such as 110, giving parameters to a function describing the amount of error at each position on the page. Alternatively, the model could be expressed in forms such as functional, tabular, or algorithmic data, or a combination thereof so long as relationships between the measured independent variables (scan position, temperature, and pressure) and a dependent variable of interest (forward-reverse alignment error or linearity error) are known. Moreover, the model may be based on empirical measured data, on theoretical physical principles, or on a combination thereof.

As a working example of the model, consider the operating point shown. If it was ascertained that the temperature of the EP device was 23.4 degrees Celsius, and the pressure (relative to some baseline, as before) was −123, a slope amount m of about 1.6 could be ascertained. Relative to other models (not shown, but plotted representatively the same), a temperature and pressure entry point would also reveal a corresponding parameter of b (y-intercept of the V-shaped curve) and an “a” value corresponding to how sharp a transition the V-shaped curve makes (a high “a” value is a very pointy V-shape whereas a low “a” value is a more rounded V-shape at the apex).

In turn, plugging the obtained or ascertained variables (m, b and a) into an equation defining the V-shaped curves of FIGS. 6A and 6B, for instance, the amount of misalignment in a bi-directionally scanning EP device can be known. Representatively, the following equation has been observed to fairly well define the V-shape of the data and plugging the obtained variables (m, b and a) into it reveals a fair approximation of the amount of misalignment in an EP device.

y(x)=[((2^{(ax)}−1)mx)/(2^{(ax)}+1))+b] Equation 2;

where x is the relative horizontal position, e.g., the x-axis as previously shown. In turn, knowing the amount of misalignment per an operating condition of the EP device, such as pressure or temperature, skilled artisan can enter a correction to compensate for the misalignment in advance of the misalignment actually occurring in a printed image. Skilled artisans will also know how to correlate or convert the amount of misalignment (e.g., a first distance) to image data input, especially in the form of pixels (pels) of a fixed length (e.g., a second distance), such as 600 or 1200 dots per inch (dpi), so that the pixel information for scanning a latent image on a photoconductor is readily also known according to pressure and/or temperature (and a correction readily implemented).

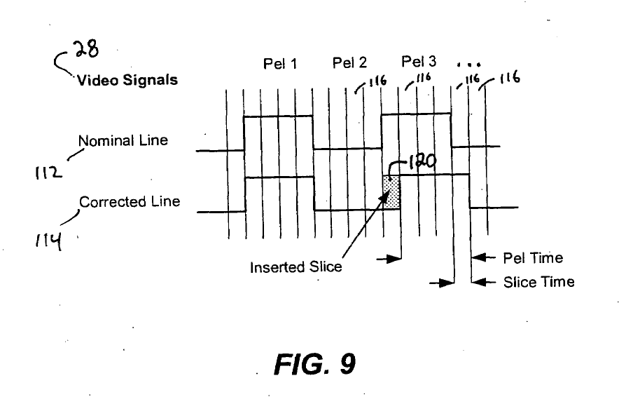

With reference to FIGS. 1 and 9, an output video signal 28 of a controller 24 either embodies a nominal line 112 or a corrected line 114 for scanning a latent image in terms of pixel (pel) information. In the former, the pixel information of the nominal line exactly or fairly closely resembles the pixel information of the image data input 22. In other words, little if any misalignment is expected and the input can be supplied directly as an output to create a scan line of a latent image. In the latter, and more realistically, a certain amount of misalignment per pressure and/or temperature is observed, and the pixel information needing to be supplied to scan a latent image needs to be altered from the image data input so that no misalignment results in the printed image output 29. Representatively, the alteration occurs by delaying certain of the pixel information from the image data input. Also representatively, pel information is sometimes known to have subsets, such as slices 116, based primarily on a system clock of the controller. In turn, the pixel information for creating the scan line of the latent image can be delayed by one or more slices. As shown, the corrected line video signal is delayed from nominal at pel 3 by a single slice 120. In other words, a slice was inserted into the pixel information. In still other words, a scan line is quantized into discrete slices, or regions in which the scanning laser may be either on or off. Quantization follows the modulation clock, since transitions between off and on states must occur between clock cycles, though each slice is generally a fraction of a pel (e.g. ¼ pel slices). Though each pel is usually composed of a fixed number of slices (e.g. 4), the relative position between any two pels can be shifted by inserting one or more slices between the pels. Alternatively, the system may be designed such that each inserted slice is always off, always on, or like a neighboring slice. Note that with a fixed pel size slice insertion method, a pel pattern may only be “stretched.” That is, the spacing between adjacent pels may only be increased. Furthermore, inserting a slice at a given location causes all remaining pels in that scan line to shift. With the V-shaped profile, therefore, inserting slices at appropriate positions in the first half of each scan should enable alignment of forward and reverse printed pels within a tolerance of approximately ±¼ pel.

Ultimately, the foregoing overcomes the expected amount of misalignment in an EP device and print quality is improved. Naturally, skilled artisans will know that other amounts of delay can be implemented as well as implementing correction schemes other than the delay/slice insertion and still overcome the expected misalignment per pressure and temperature. For instance, it should be evident that other variations include, but are not limited to, allowing variable pel size or using a continuously variable pel clock to trigger the placement of each pel.

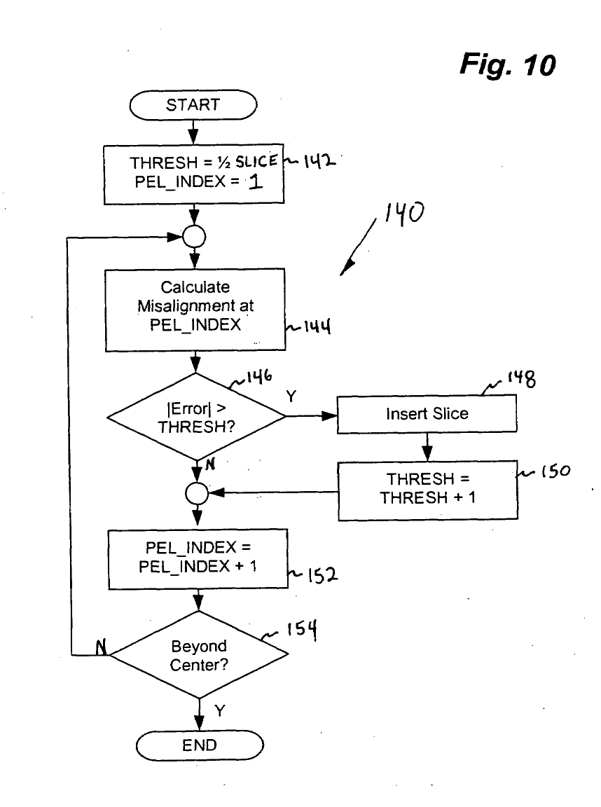

With additional reference to FIG. 10, an algorithm 140, such as algorithm A with the controller 24, FIG. 1, is employed to determine the appropriate positions in the video signal for insertion of slices into a corrected line from a nominal line representative of the image data input. In this regard, the algorithm contemplates an initialization step 142 of a threshold amount of slice insertion and a beginning pixel or pel. Because it is contemplated that a single slice of a pel will be inserted into the corrected line 114, the threshold inquiry relates to an amount of one half of a slice. That is, if it is determined that a correction for misalignment needs to occur but such is not yet quite equivalent to one-half of a slice needing to be inserted into the corrected line, there is no need to insert a slice. On the other hand, if it is determined that a correction for misalignment needs to occur and such exceeds one-half of a slice, it is then appropriate at that time to insert a slice into the corrected line. Similarly, the pel information is initialized to begin at some location. In this instance, Pel 1 is the first of the video signal and represents an intuitive start point. Of course, other or additional initializations could occur.

At step 144, the misalignment of the EP device is calculated. From earlier, this includes pre-characterizing EP devices relative to pressure and temperature and then correlating an ascertained or observed ambient pressure and temperature to same. From there, the relative variables (m, b and A, for instance) are learned and plugged into Equation 2. It is then known where on the V-shaped curve a position under consideration is located and an amount of misalignment is readily obtained. Again, the amount of misalignment might be in distances or pel slices. Also, while pressure and temperature can be measured, an inference of the ambient pressure is obtainable from other components in the EP device. For instance, it has already been described how a pulse width pw for causing a scanning mechanism to rotate will vary under the action of the feedback control. In turn, by correlating the pulse width to pressure, pressure can be inferred by simply knowing the pulse width pw.

At step 146, once the amount of misalignment is calculated, the “error” or the misalignment amount is compared to the initialized thresholds set at step 142. In this instance, if the error exceeds ½ slice, a slice is inserted into the corrected line 114 at step 148. On the other hand, if the error does not exceed the ½ slice threshold, the next pel in the video signal is examined. This is borne out by step 152 where the initialized PEL_INDEX is indexed by an amount of 1 pel. Since pel 1 was the initial pel, the next pel under consideration is then pel 2, then pel 3 and so on.

At step 150, to the extent the slice was indeed inserted into the corrected line, the threshold is incremented. That is, if it is determined in theory that pel number “n” needed two slices inserted into the corrected line 114 to correct misalignment, and pel number “n-1” already had a slice inserted, by keeping a running tally of previously inserted slices, it is known that the actual amount of insertion for pel number “n” need not actually be two inserted slices, but one. This is because the previous pel compensated for the insertion of the other slice. Representatively, a counter (such as C 11 in the controller 24 of FIG. 1) can keep track of this functionality. The counter C can also keep track of implementing the index and its amount in step 152.

In either event, step 154 examines where the corrected line 114 is located relative to actual forward or reverse scan lines that create the latent image. To the extent the forward scan line exists on the right half RH of the centerline CL, or the reverse scan line exists on the left half LH of the centerline CL (e.g., FIG. 5), no slices are inserted into the corrected line. On the other hand, if the forward scan line exists on the left half LH of the centerline CL, or the reverse scan line exists on the right half RH of the centerline CL, slices, to the extent necessary, are indeed inserted into the corrected line. Simply stated, the algorithm just determines on what side of the centerline the scan is located and if not beyond the center, the steps beginning at 144 are repeated. If beyond center, conversely, the process ends since no slices need be inserted for either the forward or reverse scan line once the respective scan line crosses the centerline. Of course, skilled artisans can contemplate other methodologies for accomplishing this.

Finally, one of ordinary skill in the art will recognize that additional embodiments of the invention are also possible without departing from the teachings herein. This detailed description, and particularly the specific details of the exemplary embodiments, is given primarily for clarity of understanding, and no unnecessary limitations are to be imported, for modifications will become obvious to those skilled in the art upon reading this disclosure and may be made without departing from the spirit or scope of the invention. Relatively apparent modifications, of course, include combining the various features of one or more figures with the features of one or more of other figures.

1. A method of improving print quality of a bi-directionally scanning electrophotographic device, comprising:
obtaining an ambient pressure under which the device is operated; and
implementing a correction based on the obtained pressure.

2. The method of claim 1, further including obtaining a temperature and implementing a correction based on the measured temperature.

3. The method of claim 1, wherein the obtaining the ambient pressure further includes ascertaining a resonant frequency of a scanning mechanism and correlating the ambient pressure therefrom.

4. The method of claim 1, further including modeling various parameters before use according to both temperature and pressure.

5. The method of claim 1, wherein the implementing the correction further includes correlating positional misalignment to pixel information for operating a laser to make scan lines in alternating directions.

6. A bi-directionally scanning electrophotographic device, comprising:
a photoconductor for being impinged with a plurality of scan lines formed in opposite directions to create a latent image; and
a controller for producing the latent image on the photoconductor with a signal altered from an image data input signal, wherein the signal altered includes pixel information delayed by an amount correlated to a positional misalignment as a function of one of an ambient pressure and a temperature in which the device is operated.

7. The device of claim 6, further including an algorithm of the controller that calculates the amount of the signal altered as a fractional amount of the pixel information.

8. The device of claim 6, further including a counter keeping track of the pixel information delayed by the amount.

9. The device of claim 6, further including an algorithm that determines whether the positional misalignment relates to a left or right half of an output image.

10. The device of claim 6, further including an algorithm that determines whether the positional misalignment relates to a forward or reverse scan line of the plurality of scan lines formed in the opposite directions to create the latent image.

11. A bi-directionally scanning electrophotographic device, comprising:
a photoconductor for being impinged with a plurality of scan lines formed in opposite directions to create a latent image; and
a controller for producing the latent image on the photoconductor with a signal altered from an image data input signal, wherein the signal altered includes pixel information delayed per a forward or reverse scan line of the plurality of scan lines formed in the opposite directions to create the latent image.

12. The device of claim 11, wherein the pixel information delayed per the forward or reverse scan lines further includes the pixel information delayed per a left or right half of the forward or reverse scan lines.

13. A bi-directionally scanning electrophotographic device, comprising:
a photoconductor for being impinged with a plurality of scan lines formed in opposite directions to create a latent image; and
a controller for producing the latent image on the photoconductor with a signal altered from an image data input signal, wherein the signal altered includes pixel information delayed per a left or right half of one of the scan lines.

14. A method of improving print quality of a bi-directionally scanning electrophotographic device, comprising:
modeling positional misalignment of the device according to both pressure and temperature;
obtaining an ambient pressure under which the device will be operated; and
correlating the obtained ambient pressure to the modeled positional misalignment.

15. The method of claim 14, further including implementing a correction based on the correlated positional misalignment.

16. The method of claim 15, wherein the obtaining the ambient pressure further includes inferring the ambient pressure from a resonant frequency of a scanning mechanism operating at the ambient pressure.

17. The method of claim 15, wherein the obtaining the ambient pressure further includes ascertaining a drive signal necessary to resonate a scanning mechanism operating at the ambient pressure.

18. A method of improving print quality in a bi-directionally scanning electrophotographic device having a moving galvanometer or oscillator for reflecting a laser beam to create scan lines of a latent image in opposite directions, comprising:
characterizing a damping of a motion of the galvanometer or oscillator relative to an ambient pressure under which the galvanometer or oscillator will operate.

19. The method of claim 18, further including characterizing the damping of the motion relative to a temperature under which the galvanometer or oscillator will operate.

20. A method of improving print quality in a bi-directionally scanning electrophotographic device having a moving galvanometer or oscillator for reflecting a laser beam to create scan lines of a latent image in opposite directions, comprising:
characterizing a damping of a motion of the galvanometer or oscillator relative to a temperature under which the galvanometer or oscillator will operate.

21. A method of improving print quality in a bi-directionally scanning electrophotographic device having a moving galvanometer or oscillator for reflecting a laser beam to create scan lines of a latent image in opposite directions, comprising:
characterizing a damping of a motion of the galvanometer or oscillator relative to an ambient pressure and a temperature under which the galvanometer or oscillator will operate;
obtaining the ambient pressure and the temperature;
correlating the obtained ambient pressure and the temperature to the characterizing the damping of the motion; and
implementing a correction to correct print quality based on the correlating.

22. The method of claim 21, further including producing the latent image with a signal altered from an image data input signal.

23. The method of claim 22, further including delaying the image data input signal by a fraction of a pixel correlated to a positional misalignment.

24. The method of claim 23, wherein the delaying the image data input signal further includes delaying according to a left or right half of the scan lines in opposite directions.

25. The method of claim 23, wherein the delaying the image data input signal further includes delaying according to whether the scan line is a forward or reverse scan line of the scan lines in opposite directions.

26. The method of claim 21, further including ascertaining a resonant frequency of the galvanometer or oscillator relative to the ambient pressure and the temperature under which the galvanometer or oscillator will operate.
